(19) United States
(12) Patent Application Publication
(10) Pub. No.: US 2008/0268223 A1
(43) Pub. Date: Oct. 30, 2008

(54) Composite sheet for mounting a workpiece and the method for making the same

(76) Inventors: Chung-Chih Feng, Kaohsiung (TW); I-Peng Yao, Kaohsiung (TW); Lyang-Gung Wang, Kaohsiung (TW); Zong-Yao Ku, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/790,963

(22) Filed: Apr. 30, 2007

(51) Int. Cl. B32B 3/26; B24B 7/04

(52) U.S. Cl. 428/304.4; 427/207.1; 427/331; 451/285; 451/289

(57) ABSTRACT

The present invention relates to a composite sheet for mounting a workpiece and a method for making the same. The composite sheet includes a buffer layer and an adsorption layer. The buffer layer has a plurality of continuous pores. The adsorption layer is located on the buffer layer for adsorbing a workpiece, and the compression ratio of the buffer layer is higher than that of the adsorption layer. Thereby, due to low hardness, good adsorption effect, and high compression ratio, the composite sheet of the present invention has good buffer effect.

### BACKGROUND OF THE INVENTION

1. Field of the Invention

The present invention relates to an adsorption sheet and a method for making the same, and more particularly, to a composite adsorption sheet for mounting a workpiece and a method for making the same.

2. Description of the Related Art

Polishing generally refers to abrasion control of an originally rough surface in a chemical mechanical polishing (CMP) process, in which a slurry containing fine particles is uniformly distributed on an upper surface of a polishing pad, and a polishing workpiece is pressed against the polishing pad to be polished regularly in a repeated pattern. The polishing workpiece is, for example, semiconductor, storage medium substrate, integrated circuit, LCD flat panel glass, optical glass, and photoelectric panel. During the polishing, it is necessary to use a sheet to support and mount the polishing workpiece, and the quality of the sheet directly affects the polishing effect of the polishing workpiece.

FIG. 1 is a schematic diagram of a polishing equipment having a conventional sheet disclosed in U.S. Pat. No. 5,871,393. The polishing equipment 1 includes a lower base plate 11, a sheet 12, a polishing workpiece 13, an upper base plate 14, a polishing pad 15, and slurry 16. The lower base plate 11 is opposite to the upper base plate 14. The sheet 12 is adhered onto the lower base plate 11 with a back adhesive layer 17, and is used to support and mount the polishing workpiece 13. The polishing pad 15 is mounted on the upper base plate 14 and facing the lower base plate 11, for polishing the polishing workpiece 13.

The polishing equipment 1 operates as follows. Firstly, the polishing workpiece 13 is disposed on the sheet 12, and is adsorbed by the sheet 12. Next, the upper base plate 14 and the lower base plate 11 are rotated in opposite directions, and meanwhile, the upper base plate 14 moves downward, so as to make the polishing pad 15 contact the surface of the polishing workpiece 13. In this way, the polishing workpiece 13 is polished by continuously supplementing the slurry 16 together with the function of the polishing pad 15.

FIG. 2 is a schematic enlarged diagram of region A in FIG. 1. The region A mainly shows the sheet 12. The sheet 12 is a single-layered structure, and the material thereof is generally polyurethane (PU) resin, which is a foam material. Furthermore, the sheet 12 has a plurality of communicating foam pores 121 inside.

During the polishing process, the polishing workpiece 13 and the sheet 12 bear a downward pressure, and the compression ratio of the sheet 12 may affect the overall stress uniformity, which is also a critical factor in determining the flatness of the polishing workpiece 13 after being polished. That is, high compression ratio represents good buffer effect, such that the polishing workpiece 13 after the polishing may acquire good flatness. In general, after long-term usage, the compression ratio of the sheet 12 will gradually descend to end the life of the sheet 12.

As the sheet 12 is a single-layer structure, if the material thereof is soft, though the adsorption to the polishing workpiece 13 is strong, the compression ratio is low; while if the material thereof is hard, though the compression ratio is high, the adsorption to the polishing workpiece 13 is weak.

Therefore, it is necessary to provide a composite sheet for mounting a workpiece and a method for making the same to solve the above problems.

### SUMMARY OF THE INVENTION

The objective of the present invention is to provide a composite sheet, which includes a buffer layer and an adsorption layer. The buffer layer has a plurality of continuous pores. The adsorption layer is located on the buffer layer, for adsorbing a workpiece, and the compression ratio of the buffer layer is higher than that of the adsorption layer. Thereby, a balance between the overall hardness and the compression ratio of the composite sheet is achieved. Moreover, the hardness or compression ratio can be adjusted optionally. Compared with the conventional sheet with a single-layer structure, the composite sheet of the present invention has lower hardness, thus better adsorption effect can be obtained; meanwhile, the composite sheet of the present invention has higher compression ratio, thus better buffer effect can be obtained.

Another objective of the present invention is to provide a method for making a composite sheet, which includes the following steps: (a) forming a resin layer on a carrier; (b) solidifying the resin layer; (c) washing the resin layer; (d) baking the resin layer, to form a buffer layer having a plurality of continuous pores; and (e) attaching an adsorption layer onto the buffer layer, to form a composite sheet, wherein the compression ratio of the buffer layer is higher than that of the adsorption layer.

### BRIEF DESCRIPTION OF THE DRAWINGS

FIG. 1 is a schematic diagram of a polishing equipment having a conventional sheet disclosed in U.S. Pat. No. 5,871,393;

FIG. 2 is a schematic enlarged diagram of region A in FIG. 1;

FIG. 3 is a schematic diagram of a polishing equipment of the present invention;

FIG. 4 is a schematic enlarged diagram of region B in FIG. 3;

FIG. 5 is a schematic flow chart of a method for making a composite sheet of the present invention;

FIGS. 6 to 9 are schematic diagrams of each process in the method for making a composite sheet of the present invention; and

FIG. 10 is an SEM photo of the composite sheet made according to an embodiment of the present invention.

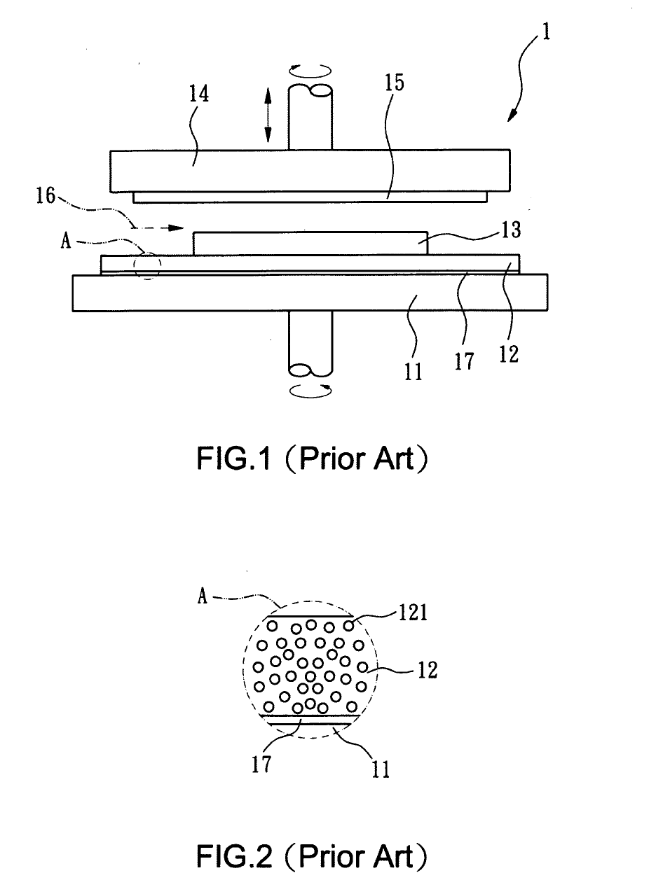

### DETAILED DESCRIPTION OF THE INVENTION

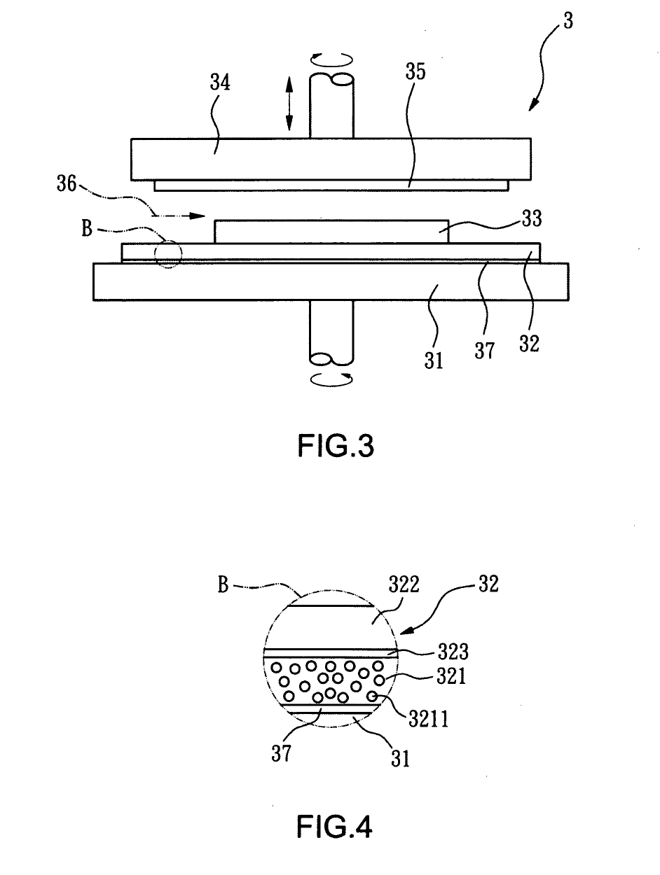

FIG. 3 is a schematic diagram of a polishing equipment of the present invention. The polishing equipment 3 includes a lower base plate 31, a composite sheet 32, a polishing workpiece 33, an upper base plate 34, a polishing pad 35, and a slurry 36. The lower base plate 31 is opposite to the upper base plate 34. The composite sheet 32 is fixed on the lower base plate 31. In this embodiment, the composite sheet 32 is adhered to the lower base plate 31 with a back adhesive layer 37, for supporting and mounting the polishing workpiece 33. The polishing workpiece 33 is selected from a group consisting of semiconductor, storage medium substrate, integrated circuit, LCD flat panel glass, optical glass, and photoelectric panel. The polishing pad 35 is mounted on the upper base plate 34 and facing the lower base plate 31, to polish the polishing workpiece 33.

The polishing equipment 3 operates as follows. Firstly, the polishing workpiece 33 is disposed on the sheet 32, and the polishing workpiece 33 is adsorbed by the sheet 32. Next, the upper base plate 34 and the lower base plate 31 are rotated in opposite directions, and meanwhile, the upper base plate 34 moves downward, so as to make the polishing pad 35 contact the surface of the polishing workpiece 33. In this way, the polishing workpiece 33 is polished by continuously supplementing the slurry 36 together with the function of the polishing pad 35.

FIG. 4 is a schematic enlarged diagram of region B in FIG. 3. The region B mainly shows the composite sheet 32. In the present invention, the composite sheet 32 is a double-layered structure including a buffer layer 321 and an adsorption layer 322. The buffer layer 321 has a plurality of continuous pores 3211, and the back adhesive 37 is formed on the lower surface of the buffer layer 321. The adsorption layer 322 is different from the buffer layer 321, and is located on the buffer layer 321, for adsorbing the polishing workpiece 33. The compression ratio of the buffer layer 321 is higher than that of the adsorption layer 322. Preferably, the void content of the buffer layer 321 is higher than that of the adsorption layer 322.

In this embodiment, the material of the buffer layer 321 is PU resin with a void content higher than 60%; preferably, higher than 75%. The material of the adsorption layer 322 is Polyurethane (PU) resin, polyvinyl chloride (PVC) resin, polystyrene resin, polyethylene resin, polyamide resin, polypropylene resin, or ethylene-vinyl acetate resin, with a void content of 30%-60%, preferably, 40%-50%. Additionally, the compression ratio of the buffer layer 321 is higher than 30%; preferably, higher than 50%. Such compression ratio can be adjusted optionally. The compression ratio of the adsorption layer 322 is 25%-40%.

In this embodiment, the adsorption layer 322 is attached to the buffer layer 321 with an adhesive layer 323, and the material of the adhesive layer 323 is a polymer elastomer, such as pressure-sensitive adhesive, moisture curable resin, one-component resin, or two-component resin.

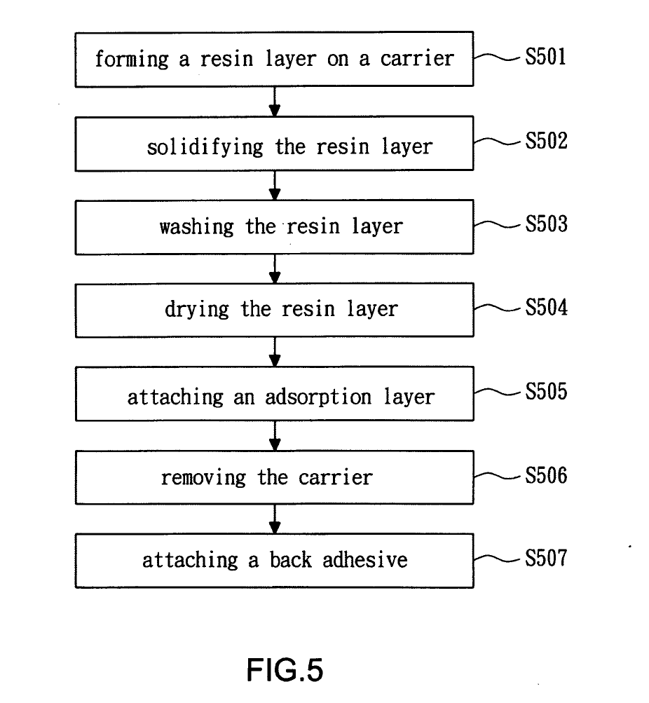

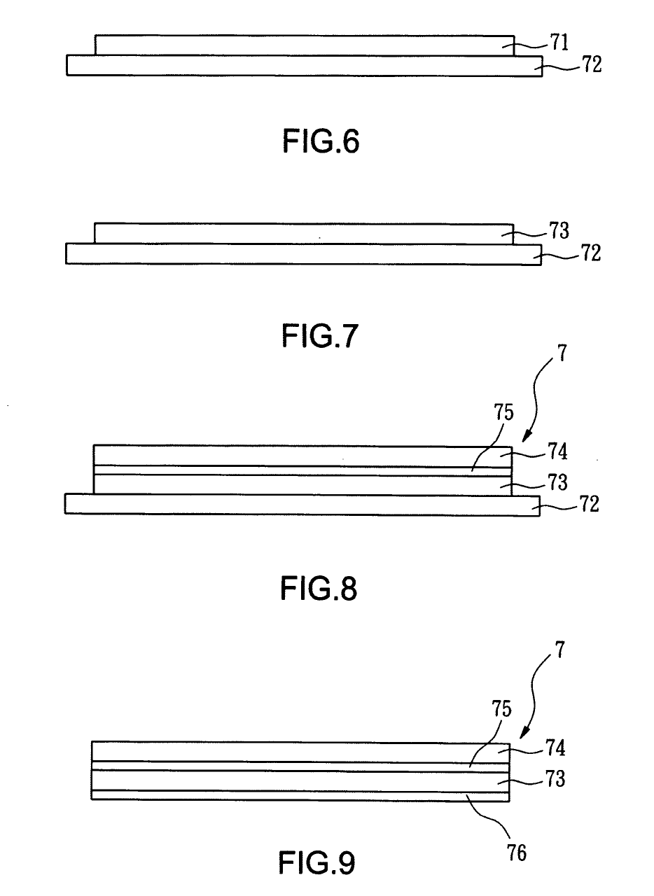

FIG. 5 is a schematic flow chart of a method for making a composite sheet of the present invention. The method includes the following steps. Referring to FIG. 6 and FIG. 5, in Step S501, a resin layer 71 is formed on a carrier 72. In this embodiment, the material of the resin layer 71 is PU resin, and the resin layer 71 is formed on the carrier 72 by coating. Afterward, in Step S502, the resin layer 71 is solidified. In Step S503, the resin layer 71 is washed. And in Step S504, the resin layer 71 is dried or baked, so as to form a buffer layer 73, as shown in FIG. 7. The buffer layer 73 has a plurality of continuous pores.

Referring to FIG. 8 and FIG. 5, in Step S505, an adsorption layer 74 is attached to the buffer layer 73, to form a composite sheet 7. The compression ratio of the buffer layer 73 is higher than that of the adsorption layer 74, and the void content of the buffer layer 73 is higher than that of the adsorption layer 74. In this embodiment, an adhesive layer 75 is formed with an attachment tool, for attaching the adsorption layer 74 onto the buffer layer 73. The material of the adhesive layer 75 is a polymer elastomer, such as pressure-sensitive adhesive, moisture curable resin, one-component resin, or two-component resin. The attachment tool can be a coating roller, coating blade, printing roller, or transfer tool.

Preferably, after the adsorption layer 74 is attached to the buffer layer 73, these two layers are left still for a day to be cured. Meanwhile, referring to FIG. 9, in Step S506, the carrier 72 is removed, and next, in Step S507, a back adhesive 76 is attached to the lower surface of the buffer layer 73, so as to form a commercialized product of the composite sheet 7.

The present invention will be described in detail with the following examples, but it does not mean that the present invention is limited to the content disclosed by the examples.

### EXAMPLE

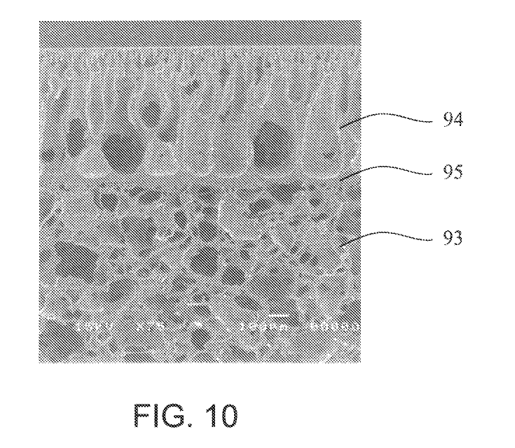

Firstly, a carrier is provided as a coating substrate, and the carrier can be polypropylene film, polyethylene terephthalate (PET) film, polyacrylic film, polyolefm film, woven fabric, or fiber glass. Additionally, 19.9 wt % of PU resin for coating, 6.6 wt % of colorant, 2.5 wt % of interface agent, and 71 wt % of dimethylformamide (DMF) solvent are mixed uniformly to prepare a coating material. Next, the coating material is coated on the carrier to form a resin layer. Then, the resin layer is solidified in a solidifying tank having 10% of DMF. Afterward, the resin layer is washed, and the water temperature is 60° C. And then, the resin layer is baked at 100° C. to form a continuous porous buffer layer. Thereafter, an adhesive layer of a polymer elastomer is formed on the buffer layer through a printing roller, and an adsorption layer of PU material is attached to the buffer layer to form a composite adhesive sheet, as shown by an SEM photo in FIG. 10. In FIG. 10, the composite sheet includes a buffer layer 93, an adsorption layer 94, and an adhesive layer 95. The void content of the buffer layer 93 is 81%, and the compression ratio thereof is 56%. The void content of the adsorption layer 94 is 37%, and the compression ratio thereof is 38%. The hardness of the composite sheet is 18 shore A, and the compression ratio thereof is 49.45%, while the hardness of the conventional sheet is above 20 shore A, and the compression ratio thereof is generally below 40%. Therefore, the composite sheet of this example has lower hardness (i.e., better adsorption effect) and higher compression ratio (i.e., better buffer effect).

In the present invention, as a composite sheet is formed by compositing two different layers, a balance can be achieved between the overall hardness and the compression ratio of the composite sheet, and moreover, the hardness or compression ratio can be adjusted optionally. That is to say, compared with the conventional sheet with a single-layer structure, the composite sheet of the present invention has lower hardness, thus better adsorption effect can be obtained, and meanwhile, the composite sheet of the present invention has higher compression ratio, thus better buffer effect can be obtained.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A composite sheet, comprising:
a buffer layer, having a plurality of continuous pores; and
an adsorption layer, located on the buffer layer, for adsorbing a workpiece, wherein the compression ratio of the buffer layer is higher than that of the adsorption layer.

2. The composite sheet as claimed in claim 1, wherein the workpiece is selected from a group consisting of semiconductor, storage medium substrate, integrated circuit, LCD flat panel glass, optical glass, and photoelectric panel.

3. The composite sheet as claimed in claim 1, wherein the void content of the buffer layer is higher than that of the adsorption layer.

4. The composite sheet as claimed in claim 1, wherein the void content of the buffer layer is higher than 60%.

5. The composite sheet as claimed in claim 1, wherein the compression ratio of the buffer layer is higher than 30%.

6. The composite sheet as claimed in claim 1, wherein the void content of the buffer layer is between 30%-60%.

7. The composite sheet as claimed in claim 1, wherein the adsorption layer is attached to the buffer layer with an adhesive layer.

8. The composite sheet as claimed in claim 7, wherein the material of the adhesive layer is a polymer elastomer.

9. The composite sheet as claimed in claim 7, wherein the adhesive layer is selected from a group consisting of pressure-sensitive adhesive, moisture curable resin, one-component resin, and two-component resin.

10. The composite sheet as claimed in claim 1, wherein the material of the buffer layer is polyurethane (PU) resin.

11. A method for making a composite sheet, comprising:
(a) forming a resin layer on a carrier;
(b) solidifying the resin layer;
(c) washing the resin layer;
(d) drying the resin layer, to form a buffer layer, wherein the buffer layer has a plurality of continuous pores; and
(e) attaching an adsorption layer to the buffer layer, to form a composite sheet, wherein the compression ratio of the buffer layer is higher than that of the adsorption layer.

12. The method as claimed in claim 11, further comprising a step of removing the carrier, and a step of attaching a back adhesive to the buffer layer.

13. The method as claimed in claim 11, wherein in step (a), the resin layer is formed on the carrier by coating.

14. The method as claimed in claim 11, wherein in step (e), an adhesive layer is formed with an attachment tool, so as to attach the adsorption layer to the buffer layer.

15. The method as claimed in claim 14, wherein the attachment tool is selected from a group consisting of coating roller, coating blade, printing roller, and transfer tool.

16. The method as claimed in claim 11, wherein in step (e), the void content of the buffer layer is higher than that of the adsorption layer.

17. The method as claimed in claim 11, wherein in step (a), the material of the resin layer is PU resin.

18. A polishing equipment, for polishing a workpiece, comprising:
an upper base plate;
a lower base plate, opposite to the upper base plate;
a composite sheet, comprising:
a buffer layer, having a plurality of continuous pores, wherein the buffer layer is fixed on the lower base plate; and
an adsorption layer, located on the buffer layer, for adsorbing the workpiece, wherein the compression ratio of the buffer layer is higher than that of the adsorption layer; and
a polishing pad, fixed on the upper base plate, and facing the lower base plate, for polishing the workpiece.

19. The polishing equipment as claimed in claim 18, wherein the workpiece is selected from a group consisting of semiconductor, storage medium substrate, integrated circuit, LCD flat panel glass, optical glass, and photoelectric panel.

20. The polishing equipment as claimed in claim 18, wherein the void content of the buffer layer is higher than that of the adsorption layer.

21. The polishing equipment as claimed in claim 18, wherein the void content of the buffer layer is higher than 60%.

22. The polishing equipment as claimed in claim 18, wherein the compression ratio of the buffer layer is higher than 30%.

23. The polishing equipment as claimed in claim 18, wherein the void content of the adsorption layer is between 30%-60%.

24. The polishing equipment as claimed in claim 18, wherein the adsorption layer is attached to the buffer layer with an adhesive layer.

25. The polishing equipment as claimed in claim 24, wherein the material of the adhesive layer is a polymer elastomer.

26. The polishing equipment as claimed in claim 24, wherein the adhesive layer is selected from a group consisting of pressure-sensitive adhesive, moisture curable resin, one-component resin, and two-component resin.

27. The polishing equipment as claimed in claim 18, wherein the material of the buffer layer is PU resin.

28. The polishing equipment as claimed in claim 18, wherein the buffer layer is attached to the lower base plate with a back adhesive layer.
